(19) United States
(12) Patent Application Publication
(10) Pub. No.: US 2001/0022804 A1
(43) Pub. Date: Sep. 20, 2001

(54) Fiber optic temperature measurement

(75) Inventors: Christian Helmig, Werl (DE); Jorg Teunissen, Ratingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: Maschinenfabrik Reinhausen GmbH

(21) Appl. No.: 09/808,235

(22) Filed: Mar. 14, 2001

(30) Foreign Application Priority Data
Mar. 14, 2000 (DE) 10012291.4

(51) Int. Cl. G01K 11/00

(52) U.S. Cl. 374/161; 374/120; 385/12

(57) ABSTRACT

A fiber Bragg grating written into a glass fiber from which a coating has been removed, serves as a temperature sensor and is surrounded by a glass capillary. An epoxy resin fills the space between the capillary and the fiber containing the Bragg grating. Broad-band light launched into the fiber optical device is reflected depending upon the measured temperature and with amplification of the effect due to the fact that the strain resulting from the difference in thermal expansion coefficient of the adhesive and the capillary is superimposed upon the temperature variation of the Bragg grating.

### FIELD OF THE INVENTION

Our present invention relates to fiber optic temperature measurement and, more particularly, to a method of measuring temperature using fiber optics and to a fiber optic temperature sensor capable of on-line monitoring of energy-producing or energy-consuming devices and apparatus for temperature detection utilizing fiber Bragg gratings.

### BACKGROUND OF THE INVENTION

The on-line measurement of temperature in energy-producing and energy-consuming devices or systems requires reliability and economy with respect to the life of the apparatus. With time, fiber-optic systems have become increasingly important for this purpose and now fiber optics plays a significant line inter alia in the detection and monitoring of parameters such as temperature at critical locations in the various devices or apparatus or at locations which tend to be particularly sensitive or are prone to damage. In fact, fiber optic devices are highly practical wherever potential-free temperature measurements are required and the requirement for temperature measurements under potential-free conditions have become increasingly important.

For the measurement of temperatures, fiber optic temperature sensors can operate under a variety of principles. For example, luminescence temperature sensors are based upon the fact that certain materials emit light by photoluminescence upon optical excitation in certain lengths. The light which is emitted is of a longer wavelength than the exciting light. The measured parameters can be either the temperature-dependent change in the spectral intensity distribution or the extinction time of luminescent light.

Thermochromic temperature sensors utilize the effect that amplitude and the spectral location of light absorption of solid and liquid substances is temperature dependent. The level of such absorption or transmission can thus be a measure of the temperature.

Interferometric sensors utilize the effect of temperature on the phase. They are highly temperature sensitive but the sensor region is not precisely localizable and hence it is difficult to measure the temperature with such sensors at exact locations.

Polarimetric sensors utilize the temperature-dependent effect of birefringence on the phase of the light wave. The temperature dependency is especially great with strongly birefringent fibers and for this purpose commercially available HiBi (high birefringency) fibers are used as a rule. These high refringency fibers in a polarimetric sensor are described in DE 196 44 885 A1.

The disadvantage with such sensors is that even the feed line running to the sensor region is temperature sensitive and thus the sensor cannot be used for accurate temperature detection on a pointwise basis and for measuring temperatures at different locations in electrical systems.

A further temperature detection system (see our copending application Ser. No. 09/652,102 field Aug. 30, 2000) utilizes a fiber grating sensor system. In such arrangements, after removal of the coating material along a defined length of a standard quartz glass optical fiber, to create a zone sensitive to the temperature measurement, a microstructured refractive index grating is written into the core of the optical waveguide at defined locations to form a so-called fiber Bragg grating which can reflect certain wavelengths of the light launched into the optical fiber. The Bragg reflection wavelength is a function of the fiber temperature and the strain on the fiber. To increase the mechanical stability of the Bragg grating region, the grating can be written into the glass fiber with laser pulses in the fiber core during the fiber drawing process. The disadvantage of this method is the reduced degree of reflection of the Bragg grating when produced in this manner.

### OBJECTS OF THE INVENTION

It is, therefore, the principal object of the present invention to provide an improved method of measuring temperatures with optical fibers utilizing the fiber Bragg grating, whereby the sensitivity is enhanced and the temperature measurement can be carried out on a point-like basis or in a quasidistributed manner with greater precision than has been possible heretofore.

Another object of the invention is to provide an improved temperature sensor which additionally has increased mechanical stability and can be fabricated in a simple and economical manner.

Still a further object of the invention is to provide a method of making the improved temperature sensor.

### SUMMARY OF THE INVENTION

These objects and others which will become apparent hereinafter are obtained, in accordance with the invention, in a fiber optic temperature measurement method comprising the steps of:

(a) providing as a temperature sensor an optical glass fiber having a Bragg grating written into a portion thereof and a reflection wavelength dependent upon an ambient temperature of the sensor, the portion of the optical glass fiber being spacedly surrounded by a glass capillary with a space between the glass capillary and the optical fiber being filled with a hardened-in-place adhesive;

(b) positioning the glass capillary at a location at which a temperature is to be measured;

(c) coupling broad-band light into the glass fiber;

(d) subjecting the glass capillary to temperature changes at the location which generate a targeted mechanical pressure on the portion provided with the Bragg grating as a result of different coefficients of thermal expansion of the glass capillary and the adhesive to produce a predetermined strain related to the temperature on the Bragg grating and a corresponding variation in the reflection wavelength λ_{BG} thereof; and

(e) analyzing light reflected from the Bragg grating and determining a total change in the reflection wavelength λ_{BG} as a measure of the temperature change ΔT.

The fiber optic sensor of the invention can comprise an optical glass fiber having a Bragg grating written into a portion thereof and a reflection wavelength dependent upon an ambient temperature of the sensor, the portion of the optical glass fiber being spacedly surrounded by a glass capillary with a space between the glass capillary and the optical fiber being filled with a hardened-in-place adhesive to generate a targeted mechanical pressure on the portion provided with the Bragg grating as a result of different coefficients of thermal expansion of the glass capillary and the adhesive at a temperature of the sensor to produce a predetermined strain related to the temperature of the Bragg grating and a corresponding variation in the reflection wavelength λ_{BG} thereof.

The method of making the sensor, in turn, can comprise the steps of:

(a) writing into a portion of an optical glass fiber a Bragg grating having a reflection wavelength dependent upon an ambient temperature of the sensor;

(b) introducing the portion of the optical glass fiber into a glass capillary while leaving a space between the glass capillary and the optical fiber;

(c) filling the space with a hardenable adhesive having a thermal coefficient of expansion when hardened which is different from that of the portion of the optical fiber; and

(d) hardening the adhesive in place to generate a targeted mechanical pressure on the portion provided with the Bragg grating as a result of different coefficients of thermal expansion of the glass capillary and the adhesive at a temperature of the sensor to produce a predetermined strain related to the temperature on the Bragg grating and a corresponding variation in the reflection wavelength λ_{BG} thereof.

According to the invention the adhesive is an epoxy resin and preferably a DELO™ type epoxy resin and most specifically an epoxy resin with a thermal expansion coefficient of 90×10⁻⁶K⁻¹. The glass capillary an be composed of quartz glass with a thermal expansion coefficient of 0.5×10⁻⁶K⁻¹.

The invention utilizes the fact that a different thermal coefficient of expansion of the quartz glass capillary on the one hand and the adhesive on the other will give rise to a defined strain which is a function of temperature variation on the fiber Bragg grating resulting in a corresponding mechanical pressure on that grating. The superimposition of the mechanical distortion resulting from temperature variation is an increase in the temperature measurement sensitivity of the Bragg grating.

The method and sensor can be used for a potential free detection of the temperature in apparatus and devices, for example electrical power equipment such as power transformers and tapping or tapping transformers at locations to which access is highly limited. The sensors allow temperatures at interior points of such apparatus to be measured with high precision and without the influence on the measurement results of temperatures at even nearby locations. The temperature measurements can make use of large numbers of such sensors in close proximity to one another without any danger that the results will be tainted by the effects of temperatures at nearby points.

### BRIEF DESCRIPTION OF THE DRAWING

The above and other objects, features, and advantages will become more readily apparent from the following description, reference being made to the accompanying drawing in which:

FIG. 1 is an information flow diagram illustrating the method of the invention;

FIG. 2 is a diagrammatic perspective view of a sensor drawn to an enlarged scale;

FIG. 3 is a diagram of a temperature measuring unit provided with a sensor according to the invention and again showing some of the parts thereof greatly enlarged in scale; and

FIG. 4 is a graph illustrating the invention.

### SPECIFIC DESCRIPTION

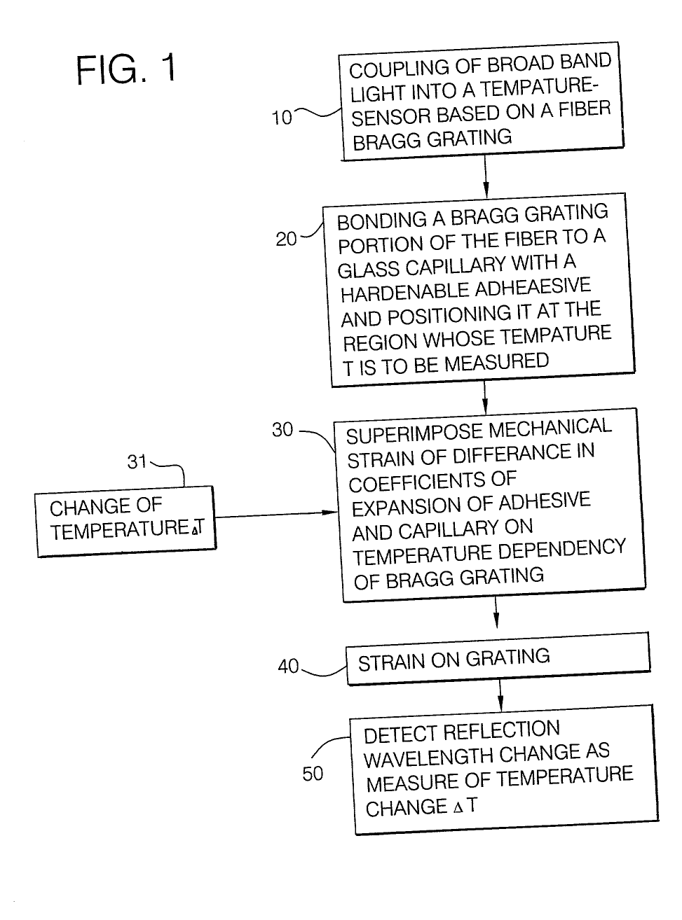

FIG. 1 diagrammatically shows the method of the invention for the fiber optical determination of temperature.

At 10, broad-band light is injected into the temperature sensor system which can comprise a sensor according to the invention based upon a Bragg grating. The region of the optical fiber in which a Bragg grating has been written is received with clearance in a quartz glass capillary and the remaining hollow space between the capillary and the fiber, in the region of the Bragg grating, is filled with a hardenable adhesive, preferably a synthetic resin. The temperature sensor is installed at 20, a location at which the temperature is to be measured. Upon a temperature change ΔT 31, because of the difference in the thermal coefficient of expansion of quartz glass and the adhesive, a mechanical pressure is generated at 30 on the grating region. This results in a defined strain on the Bragg grating as represented at 40 and the detection at 50 of changes in the reflection wavelength λ_{BG} as a measure of the temperature change ΔT.

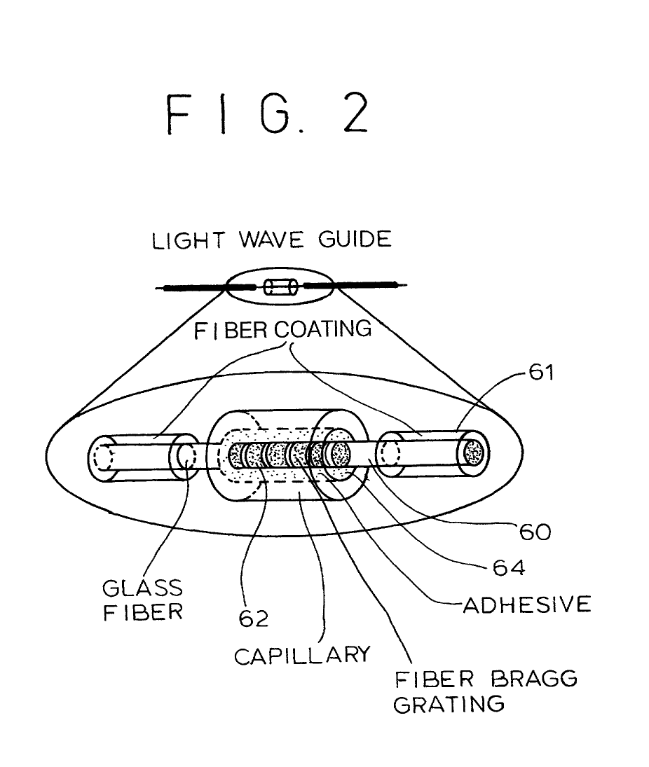

A fiber optical temperature sensor for this purpose has been shown at FIG. 2. The optical glass fiber 60 from which the coating 61 has been removed in a limited region, has a Bragg grating 62 written therein over the region denuded of the coating material. This region is enclosed in a glass capillary 63 which has an internal diameter greater than the external diameter of the glass fiber 60 without its coating. The hollow space between the glass fiber and the capillary 63 is filled with a hardenable adhesive 64. Preferably the hardenable adhesive is a DELO™ epoxy resin with a thermal expansion coefficient of 90×10⁻⁶K⁻¹. The glass capillary is composed of glass with a thermal coefficient of expansion of 0.5×10⁻⁶K⁻¹.

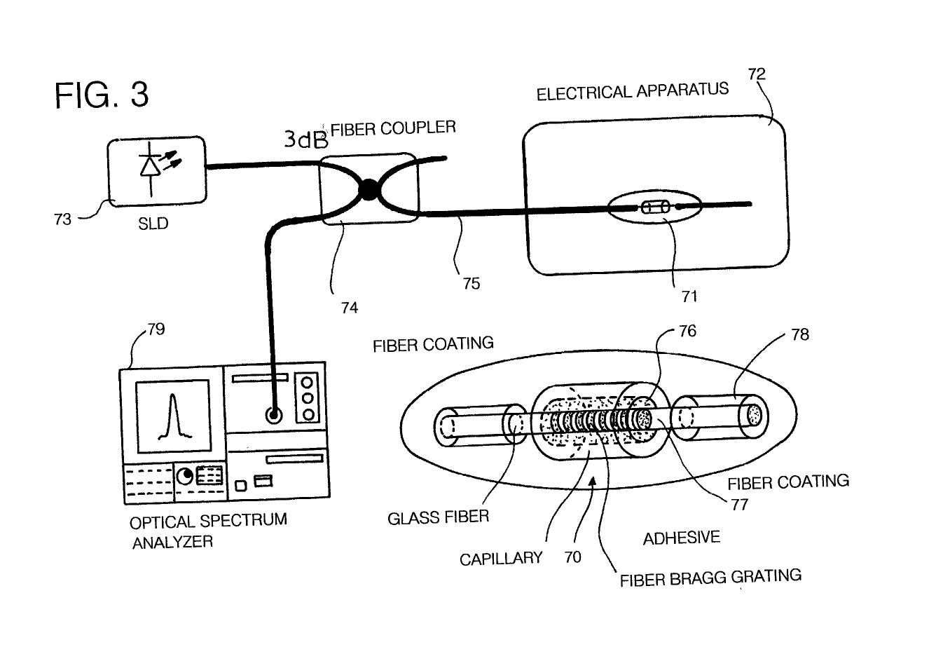

FIG. 3 shows a system for measuring the temperature utilizing a temperature sensor of the type shown in FIG. 2. The temperature sensor represented at 70 is mounted at a location 71 in an electrical apparatus 72, such as a power transformer, at which the temperature T is to be measured. By means of a superluminescent diode 73, broad-band light is launched through a 3 dB optical fiber coupler 74 into the light waveguide 75 including the fiber Bragg grating 76, the light waveguide 75 consisting of the coated fiber. The Bragg grating is written into the fiber 77 at a portion from which the coating 78 has been removed and disposed at the location 71. The output from the sensor is collected via the coupler 74 and subjected to an analysis in an optical spectrum analyzer 79. The analyzer 79 measures the change in the Bragg reflection wavelength at the fiber Bragg grating resulting from the temperature variation.

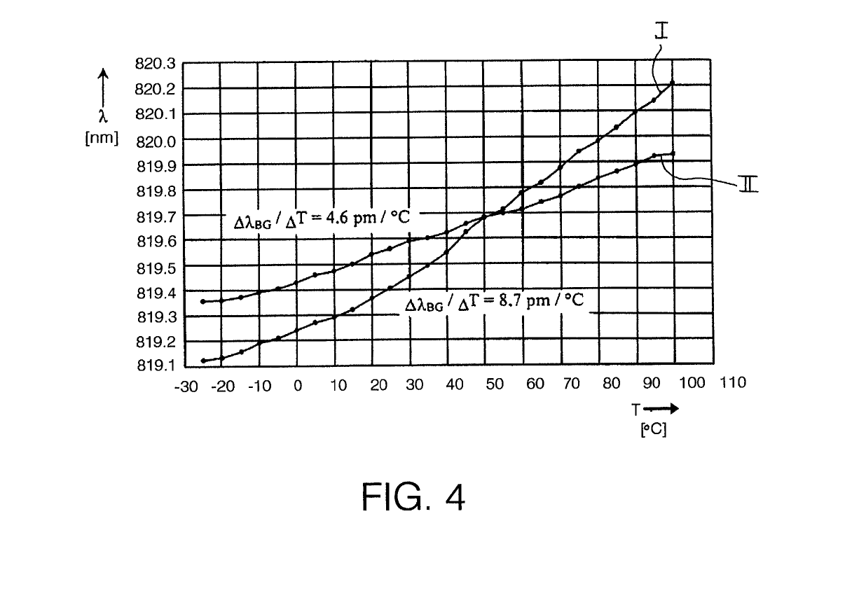

FIG. 4 shows the temperature dependency of the temperature sensor of the invention (curve I) by comparison with curve II which represents a reference measurement with a fiber Bragg grating which does not have a strain enhanced by the method of the invention with temperature variation. In the temperature range of −25° to 100° C., the Bragg reflection wavelength is clearly a function of the prevailing temperature. The mean slope of the measurement curve for the temperature sensor of the invention is about 8.7 pm/° C. The mean slope of the reference measurement curve of the state of the art sensor in the same range is 4.6 pm/° C. The graph thus shows the increased sensitivity of the sensor according to the invention resulting from the superimposition of the strain effect on the temperature variation. The result is thus an amplification of the measurement signal. The fiber Bragg grating is simultaneously protected by the glass capillary and the adhesive from mechanical effects. The temperature sensor is mechanically stable and resistant to breakage. It can be used both as a point sensor and as a quasidistributed sensor.

I claim:

1. A fiber optic temperature measurement method comprising the steps of:
(a) providing as a temperature sensor an optical glass fiber having a Bragg grating written into a portion thereof and a reflection wavelength dependent upon an ambient temperature of said sensor, said portion of said optical glass fiber being spacedly surrounded by a glass capillary with a space between said glass capillary and said optical fiber being filled with a hardened-in-place adhesive;
(b) positioning said glass capillary at a location at which a temperature is to be measured;
(c) coupling broad-band light into said glass fiber;
(d) subjecting said glass capillary to temperature changes at said location which generate a targeted mechanical pressure on said portion provided with said Bragg grating as a result of different coefficients of thermal expansion of the glass capillary and the adhesive to produce a predetermined strain related to the temperature on the Bragg grating and a corresponding variation in the reflection wavelength λ_{BG} thereof; and
(e) analyzing light reflected from said Bragg grating and determining a total change in the reflection wavelength λ_{BG} as a measure of the temperature change ΔT.

2. A fiber optic temperature measurement sensor comprising an optical glass fiber having a Bragg grating written into a portion thereof and a reflection wavelength dependent upon an ambient temperature of said sensor, said portion of said optical glass fiber being spacedly surrounded by a glass capillary with a space between said glass capillary and said optical fiber being filled with a hardened-in-place adhesive to generate a targeted mechanical pressure on said portion provided with said Bragg grating as a result of different coefficients of thermal expansion of the glass capillary and the adhesive at a temperature of said sensor to produce a predetermined strain related to the temperature on the Bragg grating and a corresponding variation in the reflection wavelength λ_{BG} thereof.

3. The fiber optic temperature measurement sensor defined in claim 2 wherein said adhesive is an epoxy resin.

4. The fiber optic temperature measurement sensor defined in claim 3 wherein said epoxy resin has a thermal expansion coefficient of 90×10⁻⁶ K⁻¹.

5. The fiber optic temperature measurement sensor defined in claim 4 wherein said glass capillary is composed of quartz glass.

6. The fiber optic temperature measurement sensor defined in claim 5 wherein said quartz glass has a thermal expansion coefficient of 0.5×10⁻⁶ K⁻¹.

7. The fiber optic temperature measurement sensor defined in claim 2 wherein said glass capillary is composed of quartz glass.

8. The fiber optic temperature measurement sensor defined in claim 7 wherein said quartz glass has a thermal expansion coefficient of 0.5×10⁻⁶ K⁻¹.

9. A method of making a fiber optic temperature measurement sensor comprising the steps of:
(a) writing into a portion of an optical glass fiber a Bragg grating having a reflection wavelength dependent upon an ambient temperature of said sensor;
(b) introducing said portion of said optical glass fiber into a glass capillary while leaving a space between said glass capillary and said optical fiber;
(c) filling said space with a hardenable adhesive having a thermal coefficient of expansion when hardened which is different from that of said portion of the optical fiber; and
(d) hardening said adhesive in place to generate a targeted mechanical pressure on said portion provided with said Bragg grating as a result of different coefficients of thermal expansion of the glass capillary and the adhesive at a temperature of said sensor to produce a predetermined strain related to the temperature on the Bragg grating and a corresponding variation in the reflection wavelength λ_{BG} thereof.

10. The method defined in claim 9 wherein said adhesive is selected as an epoxy resin having a thermal coefficient of expansion of 90×10⁻⁶K⁻¹ and said glass capillary is selected as quartz glass having a thermal expansion coefficient of 0.5×10⁻⁶ K⁻¹.
